(19) United States
(12) Patent Application Publication
(10) Pub. No.: US 2009/0188354 A1
(43) Pub. Date: Jul. 30, 2009

(54) Combination Vegetation trimmer and edger

(76) Inventor: David Harris, Rio Oso, CA (US)

Correspondence Address: MATHEW J. TEMMERMAN, 423 E STREET, DAVIS, CA, 95616, US

(21) Appl. No.: 12/011,573

(22) Filed: Jan. 28, 2008

(51) Int. Cl. A01D 42/00; A01D 34/90; A01D 34/47; A01D 34/68

(52) U.S. Cl. 83/13; 172/14; 56/12.7; 30/276

(57) ABSTRACT

A dual handled, single throttle trigger trimmer comprising rotating handles and a rotating trimmer head. The rotating handles allow the use of the trimmer in a trimming mode and an edging mode. The device may be readily converted between the two modes and the lawn care worker must not remove either hand from the device while doing so. The conversion is accomplished by rotating the trimmer upper handle about an axis perpendicular to the trimmer driveshaft while simultaneously rotating the trimmer middle handle about an axis parallel to the trimmer driveshaft. The middle handle has a slide fit around the trimmer driveshaft.

### FIELD OF THE INVENTION

The present invention relates to a weed and grass trimmer having an outwardly extending monofilament or blade that cuts vegetation when the monofilament or blade is rotating in a cutting plane. Specifically, the present invention is a dual handled, single throttle trigger weed and grass trimmer comprising dual rotating handles.

### BACKGROUND OF THE INVENTION

Many devices are in common use today to cut weeds and grass around trees, shrubs, and fences. Of these devices, some of the most well known are variations of the electric/gas trimmer. A trimmer generally comprises a rotatable trimmer head having an outwardly extending flexible monofilament or blade. As the trimmer head is rotated at a high rotational velocity, the blade or monofilament is spun in a cutting plane that shears grass and other vegetation. The rotational power may be supplied either by an electrical motor and an electrical power source such as a battery, electric power cord or fuel cell, or by an internal combustion engine carried on the trimmer. Many versions of these devices are available and history has seen many improvements to them. Improvements often focus on weight, balance, ergonomics, noise, cutting implements, and ease-of-use.

While the trimmer's primary use is for trimming weeds and grass in areas where conventional rotary mowers or other large cutting equipment are unable to gain access, trimmers are also commonly being used for “edging” sidewalks and curbs. Edging involves trimming vegetation that grows up against a sidewalk, curb or other large planar surface in a way that makes it difficult to be trimmed with a lawnmower or other large cutting device. Specific equipment is manufactured by a variety of companies solely for the task of edging. Because purchasing, maintaining and storing an addition piece of lawn care equipment can be expensive, trimmers are now commonly being secondarily used as edgers. By using the trimmer for this function, the lawn care worker is also able to edge sidewalks and curbs without having to first change out equipment between operations.

During ordinary trimming, the lawn care worker generally orients the plane of the trimmer blades (or flails or line as described below) such that they are generally parallel to the plane of the ground. Trimming in this manner produces a highly desirable even plane of cut grass, weeds or other vegetation. When the lawn care worker transitions to an edging task, the plane defined by the rotating blades, flails or line is generally perpendicular to the sidewalk and vertically aligned with the edge of the sidewalk. The lawn care worker then moves along the sidewalk while keeping the trimmer in this generally co-planar configuration between trimmer and vertical pavement surface of sidewalk edge.

Generally, reconfiguring the cutting plane of a trimmer in this manner involves completely inverting the trimmer. In conventional trimmers there is no way to reconfigure the trimmer head to allow a change in the cutting plane from generally horizontal to generally vertical, and instead the entire trimmer must be rotated. This is one large drawback to utilizing trimmer equipment for the task of edging. While professional lawn care workers may have the experience and skill to accomplish the repositioning needed to use a trimmer for edging, many casual lawn care workers and homeowners working on their own lawn may lack the acute manual dexterity and hand-eye coordination to safely use the trimmer in this manner.

In addition, using the trimmer for the purpose of edging can be dangerous for the lawn care worker, regardless of level of skill. The debris shield of a conventional trimmer is not intended to protect the user when the trimmer turned or oriented for an edging configuration. Finally, it is often very tiring for a lawn care worker to hold the trimmer in the edging orientation while walking forward along the sidewalk. A fatigued worker is more likely to be sloppy or careless, both of which can ultimately lead to injury.

Because of this and other problems, efforts have been made to combine a trimmer and an edger so that the functions of the two devices may more easily be performed by a single piece of equipment. Typically, these devices are either very heavy or very cumbersome. U.S. Pat. Nos. 4,914,899, 4,803,831, 4,756,148, 4,712,363, 4,679,385, 4,442,659, 4,224,784 and 3,788,049 all disclose trimmer add-on devices that are generally more complicated, cumbersome, and costly. These patents generally disclose an add-on type device that facilitates the orientation of the trimmer with the vertical edge of the sidewalk, either through a wheel, guide, or other mechanism that provides feedback to the lawn care worker. U.S. Pat. No. 4,268,964 provides a rotating frame on which a cutting head is supported against the horizontal top plane of the sidewalk. However, the disclosed trimmer still requires a reorientation of the entire trimmer body and many problems inherent with the process of reconfiguring a trimmer in this way are still unresolved.

Other devices in the prior art use dual throttle triggers spaced about 180 degrees apart, so that the lawn care worker may use one trigger when in horizontal trimming mode and the other trigger when in vertical edging mode. In conventional trimmers, only one throttle trigger is present and it is not always easily accessible when the trimmer is in vertical edging mode. One such device comprising dual throttle triggers is disclosed in U.S. Pat. No. 6,973,728, which has one trigger that is actuated when the trimmer is operated in trim mode (trimmer head in horizontal cutting plane) and a separate trigger that is actuated when the trimmer is operated in edge mode (trimmer head in vertical cutting plane).

Finally, other trimmers attempting to resolve the problem of how best to achieve a combination trimmer and edger have employed a rotating upper handle. Most trimmers use a first or upper handle at the end of the trimmer, generally comprising at least one throttle trigger. Most trimmers also use a second or balancing handle at approximately the midpoint of the trimmer. In trimmers using a rotating upper handle, the upper handle pivots to be selectively repositioned depending on whether the lawn care worker is trimming or edging. Generally the trimmer must be stopped and manually repositioned between the lawn care workers hands. However, even with these devices the trimmer must generally be released and grasped again by one of the lawn care worker's hands, increasing the danger associated with performing the repositioning while the trimmer is running. A related the device is disclosed in U.S. Pat. No. 6,439,088. This patent discloses a device with a rotating upper handle that requires the lawn care worker first overcome a biasing force so as to twist the upper handle from a first configuration to a second configuration. The second or balancing handle on this device comprises two separate handles separated by 180 degrees about the driveshaft of the device. Once the upper handle has been reconfigured, the lawn care worker grabs the appropriate of the two middle or balancing handles. Like much of the other prior art, this device requires the lawn care worker to perform motions that require one or both hands to leave the trimmer. This increases the danger associated with the reconfiguration and also the likelihood that the lawn care worker will skip the reconfiguration step altogether.

The present invention improves on these prior issues by not only incorporating the trimmer/edger combination into one device having just a single trigger, but also by providing for the lawn care worker a means for switching between configurations that is intuitive, simple, quick and without need for the removal of a single hand from the trimmer device.

In view of the foregoing disadvantages inherent in the known types of combination trimmer and edgers now present in the prior art, it is thus a primary object of the invention to provide a combination trimmer and edger allowing a simple transition from trim mode to edge mode while not requiring the lawn care worker to remove his or her hands from the device.

It is a second object of the invention to provide a combination trimmer and edger not requiring more than one throttle trigger.

It is a third object of the invention to provide a trimmer a combination trimmer with dual rotating handles.

Additional objects and advantages of the present invention will become obvious to the reader and it is intended that these objects and advantages be within the scope of the present invention.

### SUMMARY OF THE INVENTION

The present invention relates to a dual handled, single throttle trigger trimmer comprising rotating handles and a rotating trimmer head. The rotating handles allow the use of the trimmer in a trimming mode and an edging mode. The device may be readily converted between the two modes and the lawn care worker must not remove either hand from the device while doing so. The conversion is accomplished by rotating the trimmer upper handle about an axis perpendicular to the trimmer driveshaft while simultaneously rotating the trimmer middle handle about an axis parallel to the trimmer driveshaft. The middle handle has a slide fit around the trimmer driveshaft.

### BRIEF DESCRIPTION OF THE DRAWINGS

The foregoing aspects and many of the attendant advantages of the invention will become more readily appreciated as the same becomes better understood by reference to the following detailed description, when taken in conjunction with the accompanying drawings, wherein:

FIG. 1 is a first environmental perspective view of a combination trimmer and edger according to a preferred embodiment of the invention, the combination trimmer and edger illustrated in a trimming configuration;

FIG. 2 is a second environmental perspective view of a combination trimmer and edger according to the preferred embodiment of the invention, the combination trimmer and edger illustrated in an edging configuration;

FIG. 3 is an enlarged right side elevational view of the upper handle of the combination trimmer and edger shown in FIGS. 1 and 2, with a portion of the trimmer removed from the illustration for purposes of clarity. Movement lines and a phantom handle depict the edging configuration, while solid handle lines depict the trimming configuration.

FIG. 4 is an enlarged left side elevational view of the middle handle of the combination trimmer and edger shown in FIGS. 1 and 2, with portions of the trimmer removed from the illustration for purposes of clarity. The trimmer is in the trimming or horizontal configuration. Cross sectional lines taken along 6-6 and 7-7 are depicted.

FIG. 5 is an enlarged left side elevational view of the middle handle of the combination trimmer and edger shown in FIGS. 1 and 2, with portions of the trimmer removed from the illustration for purposes of clarity. The trimmer is in the edging or vertical configuration.

FIG. 6 is a cross-sectional view taken along cutline 6-6 in FIG. 5.

FIG. 7 is a cross-sectional view taken along cutline 6-6 in FIG. 5.

### DETAILED DESCRIPTION OF THE INVENTION

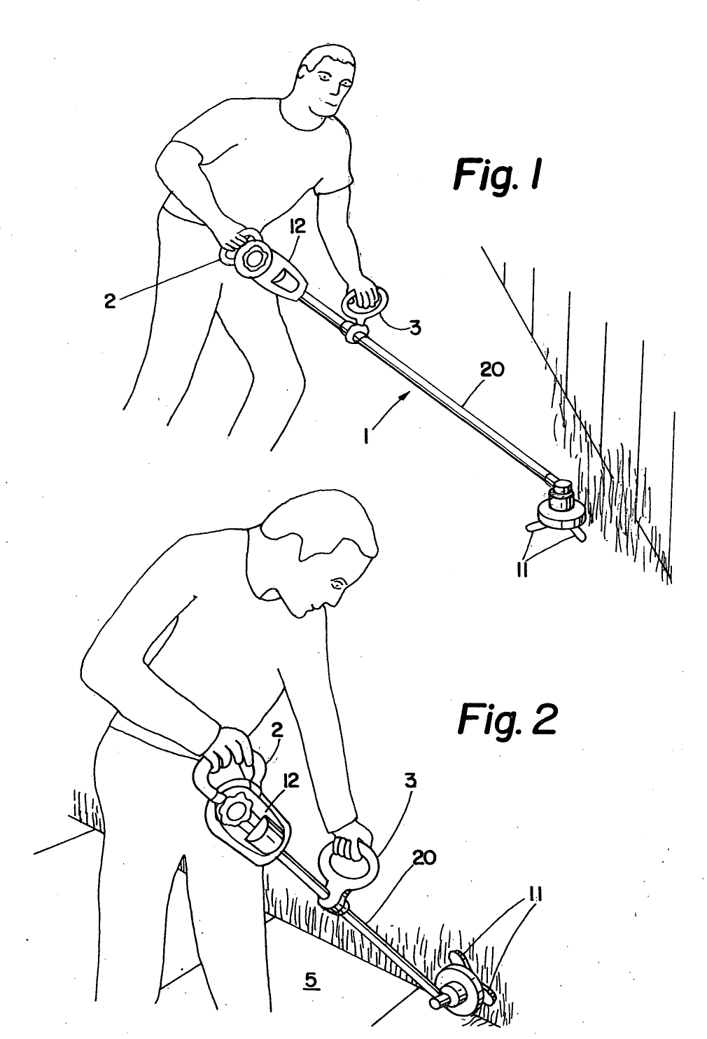

The preferred embodiment of the combination trimmer and edger is depicted in FIGS. 1-7. In these figures, a bladed trimmer is illustrated. However, the traditional blade can in alternative embodiments of the invention be interchanged with other cutting devices, such as flails, monofilament lines and strings. For purposes of simplicity in this application, the term blade has been chosen for use throughout.

At first appearance, the device appears generally as a conventional trimmer. An electrical power source such as a battery, electric power cord or fuel cell an internal combustion engine powers the trimmer 1 by rotating a driveshaft 20 to which is connected a trimmer head 10. See FIGS. 1 and 2.

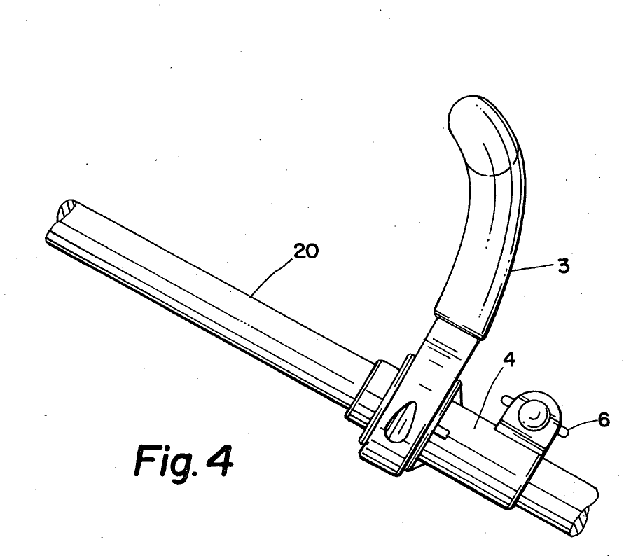

Generally stated, the dual rotatable handled trimmer 1 disclosed herein can be used in two preferred configurations. A first configuration, hereinafter referred to as trim mode, is depicted in FIG. 1 and FIG. 4. Here, trimmer head 10 is placed generally parallel to the ground such that blades 11 rotate in a generally horizontal cutting plane so as to trim vegetation at a height above the ground dependent upon the distance between the trimmer head and the ground beneath it. A second configuration, hereinafter referred to as edge mode, is depicted in FIG. 2 and in FIG. 5. In this mode, the trimmer head 10 is generally perpendicular to the ground such that the blades 11 are rotated in a generally vertical cutting plane that is vertically aligned with the vertical edge of a sidewalk, curb, or other structure against which edging is desired. In FIG. 2, sidewalk 5 is depicted as the structure against which edging is desired.

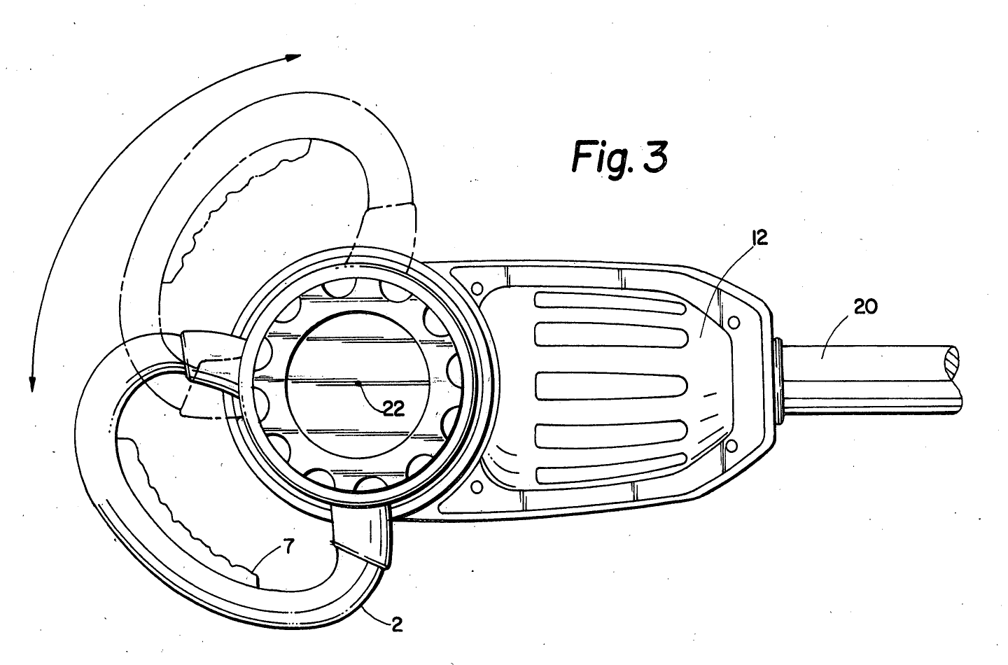

The rotating handles allow a lawn care worker to easily convert the device from trim mode to edge mode. A first handle, referred to as upper handle 2 is attachable to motor housing 12, as depicted in FIGS. 1, 2 and 3. As best shown in FIG. 3, upper handle 2 is rotatable about an upper handle axis of rotation 22 that is generally perpendicular to driveshaft 20. Continuing with FIG. 3, solid lines indicate the position of the upper handle when the device is in trim mode. In this configuration, the lawn care worker controls the device using throttle 7 and grasping upper handle 2 with one hand. Phantom lines in FIG. 3 depict the position of upper handle 2 when the device is in edge mode. Throttle 7 is wide enough to allow ease of use regardless of the configuration of the device.

Attached to driveshaft 20 in a rotatably sliding fit manner is middle handle 3. See FIGS. 1 and 2. Although it may at first appear middle handle 3 is in fact in the same position in both FIGS. 1 and 2 or alternatively, in FIGS. 4 and 5, it is in fact a different rotational position about driveshaft 20. It may ease understanding of the differences in mode to consider the middle handle 3 stationary and the driveshaft 20 and trimmer head 10 rotating about it. Although they rotate relative to one another, for purposes of this application, however, the driveshaft 20 will remain the fixed point of reference and middle handle 3 will be said to rotate around it. A detailed view of the rotation of middle handle 3 is depicted in FIGS. 4 and 5. Turning now to these figures, FIG. 4 shows middle handle 3 in trim mode while FIG. 5 shows middle handle 3 in edge mode. Middle handle axis of rotation 23 is parallel to driveshaft 20, and in this preferred embodiment actually shares an axis of rotation with driveshaft 20. See FIG. 7.

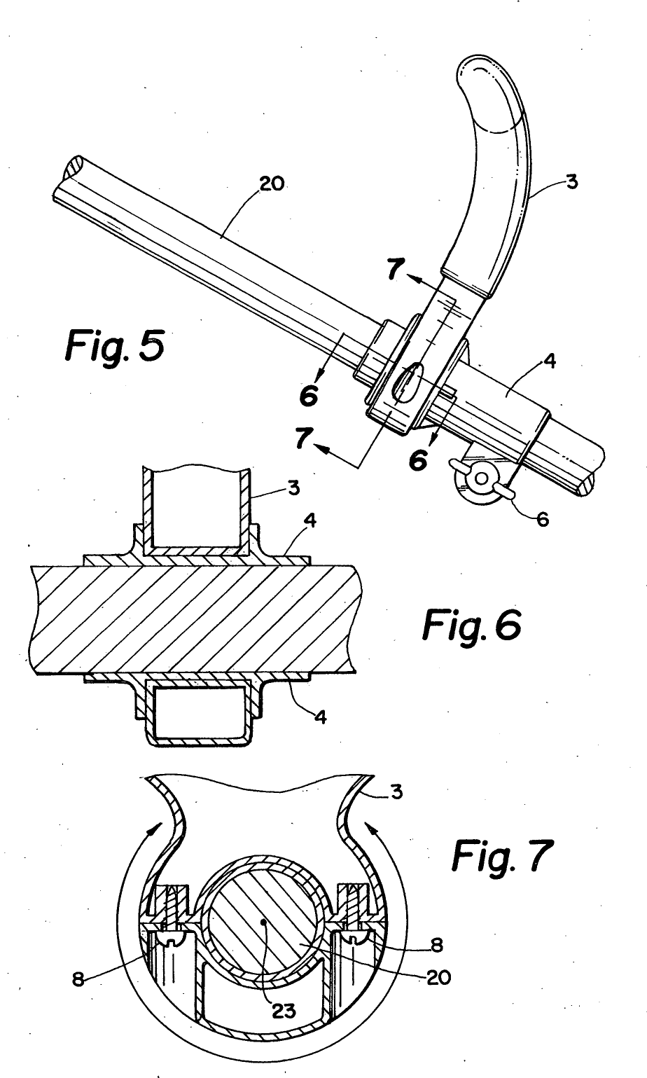

The connecting means between middle handle 3 and driveshaft 20 allows for loose rotatable movement of the handle without allowing longitudinal sliding motion along the driveshaft 20. See FIG. 5. A handle connector 4 may be used as a buffer between driveshaft 20 and middle handle 3, as best depicted in FIG. 5, but also visible in cross section FIGS. 6 and 7. Returning to FIG. 5, a wing nut 6 is depicted securing handle connector 4 tightly in place, so as to prevent longitudinal sliding along driveshaft 20. Although in this preferred embodiment handle connector 4 is depicted, in alternative embodiments of the invention this component may be omitted and middle handle 20 may rotate about driveshaft 20 whilst in direct contact with said driveshaft 20. For ease of manufacturing and repair purposes, handle 3 may comprise two halves that are brought together around driveshaft 20 and secured in place via screw 8. See FIG. 7.

In use the trimmer 10 may be readily converted between the two modes without the need for the lawn care worker to remove either hand from the device while doing so. The conversion is accomplished by rotating the trimmer upper handle about its described axis while simultaneously rotating the middle handle about its described axis. The trimmer head is partially inverted from this motion, changing from a substantially horizontal cutting plane to a substantially vertical cutting plane. The slide fit of both handles may allow some unintended rotation, but because the center of gravity (not shown) of the trimmer is below both handles in while the trimmer is in either configuration, the force of gravity will tend to hold both handles in place until the lawn care worker performs the change in configuration. If additional stability is needed, locking means for the handles are described subsequently in the alternative embodiment of the invention portion of this application.

In an alternative embodiment of the invention (not shown), the upper handle is releasably locked into each of said device configurations. In this embodiment, whether the device is in trim mode or in edge mode, the handle remains locked into position until a release button is actuated. Only upon actuation of the release button is the upper handle able to freely move between modes. This embodiment more securely locks the device into one of the two described modes.

In a second alternative embodiment of the invention, the middle handle is releasably locked into each of said device configurations. In this embodiment, whether the device is in trim mode or in edge mode, the middle handle remains locked into position until a release button is actuated. Only upon actuation of the release button is the middle handle able to freely move between modes. This embodiment more securely locks the device into one of the two described modes. The upper handle described in the aforementioned alternative embodiment of the invention can also be combined with the middle handle as described in the second alternative embodiment of the invention to make up a third alternative embodiment of the invention.

With respect to the above description then, it is to be realized that material disclosed in the applicant's drawings and description may be modified in certain ways while still producing the same result claimed by the applicant. Such variations are deemed readily apparent and obvious to one skilled in the art, and all equivalent relationships to those illustrated in the drawings and equations and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact disclosure shown and described, and accordingly, all suitable modifications and equivalents may be resorted to, falling within the scope of the invention.

I claim:

1. A combination trimmer and edger comprising:
a. a rotatable trimmer head comprising an radially outwardly extending cutting surface;
b. a driveshaft connecting a power source to said trimmer head;
c. an upper rotating handle rotatable about an axis perpendicular to said driveshaft and capable of being configured in a first configuration and a second configuration;
d. a middle rotating handle rotatable about an axis parallel to said driveshaft and capable of being configured in a first configuration and a second configuration; and
e. wherein when both rotating handles are in said first configuration said cutting surface is in a generally horizontal cutting plane with reference to the ground and wherein when both rotating handles are in said second configuration said cutting surface is in a generally vertical cutting plane with reference to the ground.

2. The combination trimmer and edger according to claim 1 wherein said middle rotating handle is slide fit connection to said driveshaft.

3. The combination trimmer and edger according to claim 2 wherein said cutting surface comprises cutting line.

4. The combination trimmer and edger according to claim 3 wherein each of said rotating handles further comprise a handgrip.

5. The combination trimmer and edger according to claim 1 wherein said middle handle is rotatable through between 145 and 215 degrees.

6. The combination trimmer and edger according to claim 1 wherein said middle handle is rotatable through between 160 and 200 degrees.

7. The combination trimmer and edger according to claim 6 wherein said middle rotating handle is slide fit connection to said driveshaft.

8. The combination trimmer and edger according to claim 7 wherein said cutting surface comprises cutting line.

9. The combination trimmer and edger according to claim 8 wherein each of said rotating handles further comprise a handgrip.

10. A combination trimmer and edger comprising:
a. a rotatable trimmer head driven by a driveshaft, said trimmer head having an outwardly extending cutting line; and
b. an upper handle rotatable about an axis generally parallel to said driveshaft and having a first and second configurations and a middle handle rotatable about an axis generally perpendicular to said driveshaft and having a first and second configurations, both handles of which an operator can grip to operate the trimmer in either a trim mode wherein both handles are in said first configuration or an edge mode wherein both handles are in said second configuration.

11. The combination trimmer and edger according to claim 1 wherein said middle handle is rotatable through between 145 and 215 degrees.

12. The combination trimmer and edger according to claim 11 wherein said middle rotating handle is slide fit connection to said driveshaft.

13. The combination trimmer and edger according to claim 12 wherein said cutting surface comprises cutting line.

14. The combination trimmer and edger according to claim 13 wherein each of said rotating handles further comprise a handgrip.

15. A method of reconfiguring a trimmer from functioning in a trim mode to functioning in an edge mode, the method comprising:
a. providing a trimmer comprising:
i. a rotatable trimmer head driven by a driveshaft, said trimmer head having an outwardly extending cutting surface that in a first configuration cuts in a generally horizontal plane with relative to the ground and in a second configuration cuts in a generally vertical plane relative to the ground;
ii. an upper handle rotatable about an axis generally parallel to said driveshaft; and
iii. a middle handle having a coupling mechanism for adapting said middle handle to said driveshaft, wherein said coupling mechanism is adapted to rotationally bias said middle handle relative to said driveshaft; and
b. applying a twisting force to both handles so as to rotate both handles about their axis of rotation and changing said rotatable trimmer head from said first configuration to said second configuration.

16. The method of 15 further comprising grasping each said handle and wherein during said applying step said hands continue to grasp said handles.

17. The combination trimmer and edger according to claim 16 wherein said middle handle is rotated between 145 and 215 degrees.

18. The combination trimmer and edger according to claim 12 wherein said cutting surface comprises cutting line.
